(19) United States
(12) Patent Application Publication
(10) Pub. No.: US 2013/0037031 A1
(43) Pub. Date: Feb. 14, 2013

(54) TUBE WITH PROTRUSIONS FOR INFLATABLE HARNESS OF BREATHING MASK

(71) Applicant: Simon Gredat, Versailles (FR)

(72) Inventor: Simon Gredat, Versailles (FR)

(73) Assignee: INTERTECHNIQUE, Plaisir, Cedex (FR)

(21) Appl. No.: 13/641,872

(22) PCT Filed: Aug. 2, 2010
(86) PCT No.: PCT/IB2010/003097

§ 371 Date: Oct. 18, 2012

(51) Int. Cl. A62B 18/08

(52) U.S. Cl. 128/205.25

(57) ABSTRACT

A tube (23) for inflatable harness (1) of a breathing mask (3), the tube (23) is gas impermeable, supple and has an inner surface (22) and an outer surface (24), wherein the inner surface (22) of the tube (23) includes a plurality of protrusions (30).

### FIELD OF THE INVENTION

The invention relates to a tube and an inflatable harness for aircraft breathing mask which includes the inflatable harness.

### BACKGROUND OF THE INVENTION

The respiratory mask typically worn by aircraft crewmembers must be attached surely and rapidly on the crewmember head. And it must be attached on an one-handed basis, since the user's other hand is frequently occupied in some other essential task.

For example, if because of a pressurization failure, the pilot of an aircraft is required rapidly to don his respiratory mask to provide the necessary oxygen for breathing, he often must do so with one hand while his other hand is occupied in controlling the aircraft. Thus, the use of an inflatable head harness has been suggested in order to permit the respiratory mask to be donned using only one hand. The head harness has substantially a dome shape and is expanded diametrically by the introduction of pressurized gas to cause the harness to increase in size so that it can be positioned over the head of the user. The gas flow is controlled by a valve attached to the respiratory mask, and, after enlargement, the respiratory mask is placed in position over the nose and mouth, with the head harness extended over and spaced from the back of the head. Once the respiratory mask has been properly positioned, the pressure in the head harness is released, causing the harness to contract and to contact the head of the pilot, whereby the respiratory mask is securely held in its proper position. Meanwhile, the pilot's other hand is free to control the aircraft or to perform such other tasks as may be required.

An inflatable head harness is shown and described in US2003/0000530 in which the tube is gas impermeable, supple, has an inner surface and an outer surface, and is inserted within a sheath. The tube is radially and axially expandable.

### SUMMARY OF THE INVENTION

The invention aims at providing a more reliable inflatable harness.

In accordance with the invention, the inner surface of the tube includes a plurality of protrusions.

The inflatable harnesses according to prior art was satisfying. The applicant has realized that the time required to inflate the harness depends on the way of stowing the harness. According to the way of folding the harness, the gas can be slow down in the harness until the whole harness is deployed.

According to the invention, while the harness folded, there is always a path for the gas whatever the folding of the harness. Hence the inflation of the harness is without delay along the whole tube.

In particular embodiments, the tube may include one or several of the advantageous following features:
the protrusions comprise ribs extending along the tube;
the tube has a first end and a second end, and each rib extends continuously between the first end and the second end;
the tube includes between 6 and 12 ribs;
in cross section, the ribs are evenly distributed;
the protrusions have a tip and the tip has an angle ranging between 60 degrees and 120 degrees;
the protrusions extend from a base end to a tip end, and the protrusions have a width evenly decreasing from the base end to the tip end;
the tube has a base portion having a smooth inner surface and the protrusions protrude from the inner surface of the base portion;
the protrusions are integral with the base portion;
the protrusions protrude between 0.2 millimeter and 1 millimeter; and
the tube is in silicon material.

The invention further relates to an elastic tubular device comprising the tube and a sheath surrounding the tube.

Preferably, the sheath is made of a woven cloth of flame resistant meta-aramid yarns.

The invention further relates to a breathing mask for aircraft comprising an inflatable harness comprising elastic tubular devices.

### BRIEF DESCRIPTION OF THE DRAWINGS

These and other aspects of the invention will be apparent from and elucidated with reference to the embodiment described hereafter where:

FIG. 1 is a perspective view of a breathing mask with its inflatable harness according to an embodiment of the invention;

FIG. 2 is a perspective view of a portion of a tubular member of the harness of FIG. 1; and

FIG. 3 is a cross section view of a tube of the tubular member of FIG. 2;

FIG. 4 is a cross section view of the tubular member of FIG. 2 in case the tube is folded in two.

### DETAILED DESCRIPTION

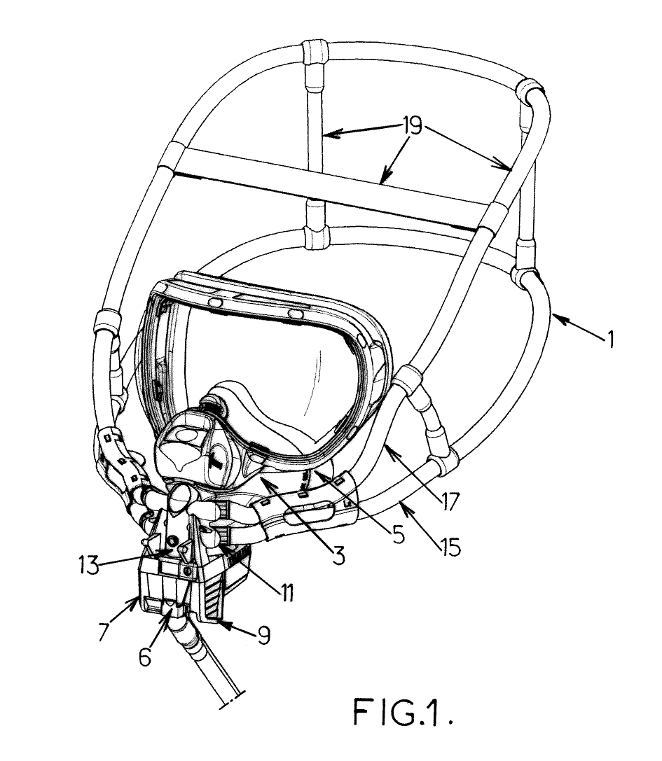

In reference to FIG. 1, a head harness 1 is utilized in conjunction with a respiratory mask 3 of the type intended to provide oxygen to aircraft crewmembers under high altitude conditions or under conditions in which the aircraft cabin pressurization has for some reason been lost.

The mask 3 includes a flexible, generally cup-shaped face member 5 adapted to fit over and cover the mouth and nose of the user, and which is suitably shaped to provide a comfortable fit.

Positioned at the forward outer end of the face member 3 is a control valve 6 having a slidable valve member 7, 9 positioned on each side of the control valve 6, each of which is adapted to selectively open and close a passage way to admit a pressurized fluid to the harness structure, all will hereinafter be described. The control valve 6 can be a two-position valve, wherein in one position it permits communication between the head harness and the atmosphere while it simultaneously prevents the entry of pressurized gas to the harness structure. As it is apparent, control valve 6 is adapted for one-handed use, thereby permitting the other hand of the user to be occupied with other tasks. Although a specific structure of control valve is shown and described, it will be apparent to those skilled in the art that other types of control valve structure could be successfully utilized together with the head harness structure of the invention, and the control valve structure shown is for illustrative purposes only.

The control valve 6 includes a valve housing 11, which fits over and is secured to a forward portion 13 of the face member 3, and to which is attached two tubular members 15, 17, each tubular member having the form of a loop, each end of which is securely received in housing in substantially gas-tight relationship. Tubular members 15, 17 are adapted to encircle the head of the user and, when properly positioned they securely hold face member 3 in its operative position. Space members 19 are positioned there between to hold the tubular elements 15, 17 in a predetermined, spaced angular relationship relative to each other for maximum comfort on the part of the user.

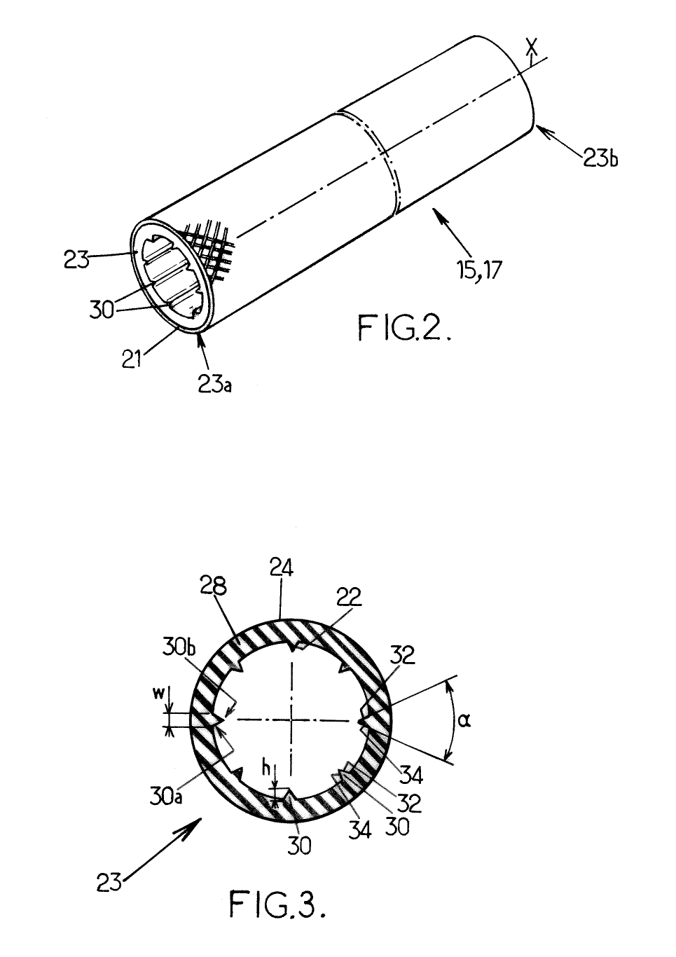

As shown in particular in FIG. 2, the tubular members 15, 17 include a tube 23 and a sheath 21. The sheath 21 is made from an elastic material which is elastically extensible in an axial or longitudinal direction, but which need not be elastically extensible in a radial or transverse direction. The purpose of the longitudinal extensibility is to permit axial extension of the tubular members 15, 17 to enable their placement over the head of the user, and subsequently to permit it to contract into closely fitting engagement with the user's head to hold the device to which it is applied on its proper position. A preferred material from which the sheath 21 can be formed is a woven cloth composed of flame resistant meta-aramid yarn such as NOMEX (trademark of Dupont Inc.) fiber. The NOMEX has the advantage to have a good heat resistance compatible with aircraft regulation, a great mechanical resistance and particularly to defibering, and a homogeneous sliding between fibers which guarantee a homogeneous elongation of the tubular members.

As shown in FIGS. 2 and 3, the tube 23 extends along a longitudinal axis 23 between a first end 23a and a second end 23b. The tube 23 has an inner surface 22 and an outer surface 24. The outer surface 24 is smooth and surrounded by the sheath 21. The tube 23 fits completely within the sheath 21 when inflated and is formed from a fluid impermeable, supple and elastic material, preferably a silicone-type material. Typically, tube 23 is a silicone molded tube.

Therefore, the tube 23, being fluid impermeable, supple and elastic, is used to transform the breathing gas pressure into a mechanical increase of the tubular members length and the sheath 21 is used for protecting the tube 23 from aggressive contact and to direct the force generated by the breathing gas pressure to the longitudinal extension of the tubular members.

The tube 23 comprises a base portion 28 and ribs protruding from the base portion 28 on the inner surface 22 of the tube 23. Preferably, the ribs are integral with the base portion 28, the tube 23 is made by extrusion and the ribs 30 extend along the longitudinal axis X.

The ribs 30 extend between the first end 23a and the second end 23b of the tube 23. As shown in FIG. 3, the ribs 30 are angularly evenly distributed. In the embodiment shown in FIGS. 2 and 3, the tube 23 comprises eight inner ribs 30, i.e. one every 45 degrees.

All the ribs 30 have the same bevel shape. They protrude from the inner surface 26 of the base portion 28 from a base end 30a to a tip end 30b. The ribs 30 have two lateral surfaces 32, 34 extending between the base end 30a and the tip end 30b. The lateral surfaces 32, 34 of each rib 30 join at the tip end 30b. Both of the lateral surfaces 32, 34 are flat.

The inner surface 22 of the tube 23 is composed of the inner surface 26 of the base portion 28 and the lateral surfaces 32, 34 of the ribs.

The lateral surfaces 32, 34 define between them an angle α, which is preferably between 60 degrees and 120 degrees, advantageously substantially equal to 90 degrees.

The height h of the ribs 30 between the base end 30a and the tip end 30b is preferably between 0.2 millimeter and 1 millimeter, advantageously substantially equal to 0.4 millimeter.

The ribs 30 have a width evenly decreasing from the base end 30a to the tip end 30b. The width w of the ribs 30 at the base end 30a is preferably between 0.4 millimeter and 2 millimeters, advantageously substantially equal to 0.8 millimeter.

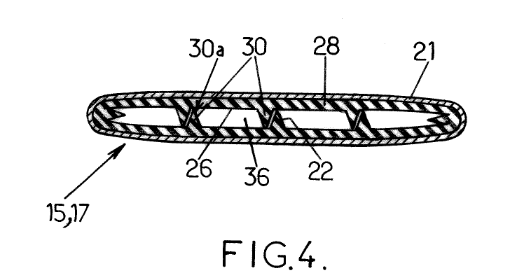

When the tube 23 is deflated, in case the tube 23 is folded in two, as shown in FIG. 4, the contact between two portions of the inner surface 22 is restricted to lines defined by the tip end 30a of the ribs 30 contacting the inner surface 26 of the base portion 28. Therefore, a path 36 for the gas is kept and the time required to inflate the harness is not substantially increased.

Other variation to the disclosed embodiments can be understood and effected by those skilled in the art in practicing the claimed invention, from a study of the drawings, the disclosure and the appended claims. For example, all the rib may not have the cross section. Otherwise, the ribs may not be straight, but extend helically around the longitudinal axis X.

In the claims, the word “comprising does not exclude other elements, and the indefinite article “a” or “an” does not exclude a plurality.

1. An elastic tubular device for inflatable harness of breathing mask, the elastic tubular device comprises a tube and a sheath surrounding the tube, the tube is gas impermeable, supple and has an inner surface and an outer surface, wherein the inner surface of the tube includes a plurality of protrusions.

2. The elastic tubular device according to claim 1 wherein the protrusions comprise ribs extending along the tube.

3. The elastic tubular device according to claim 2 having a first end and a second end, and each rib extends continuously between the first end and the second end.

4. The elastic tubular device according to claim 2 including between 6 and 12 ribs.

5. The elastic tubular device according to claim 2 wherein in cross section the ribs are evenly distributed.

6. The elastic tubular device according to claim 1 wherein the protrusions have a tip having an angle ranging between 60 degrees and 120 degrees.

7. The elastic tubular device according to claim 1 wherein the protrusions extend from a base end to a tip end and the protrusions have a width evenly decreasing from the base end to the tip end.

8. The elastic tubular device according to claim 1 wherein the tube has a base portion having a smooth inner surface and the protrusions protrude from the inner surface of the base portion.

9. The elastic tubular device according to claim 8 wherein the protrusions are integral with the base portion.

10. The elastic tubular device according to claim 1 wherein the protrusions protrude between 0.2 millimeter and 1 millimeter.

11. The elastic tubular device according to claim 1 wherein the tube is in silicon material.

12. (canceled)

13. The elastic tubular device according to claim 1 wherein the sheath is made of a woven cloth of flame resistant meta-aramid yarns.

14. A breathing mask for aircraft comprising an inflatable harness comprising elastic tubular devices according to claim 1.
